(19) United States
(12) Patent Application Publication
(10) Pub. No.: US 2018/0370314 A1
(43) Pub. Date: Dec. 27, 2018

(54) TRANSVERSE LEAF SPRING ARRANGEMENT OF A CHASSIS AXLE OF A MOTOR VEHICLE

(71) Applicant: Dr. Ing. h.c. F. Porsche Aktiengesellschaft, Stuttgart (DE)

(72) Inventor: Andreas Higle, Stuttgart (DE)

(73) Assignee: Dr. Ing. h.c. F. Porsche Aktiengesellschaft, Stuttgart (DE)

(21) Appl. No.: 15/975,170

(22) Filed: May 9, 2018

(30) Foreign Application Priority Data
Jun. 23, 2017 (DE) 102017113971.0

(51) Int. Cl. B60G 11/113; B60G 11/08

(52) U.S. Cl. CPC B60G 11/113; B60G 2204/424; B60G 2204/418; B60G 11/08

(57) ABSTRACT

A transverse leaf spring arrangement of a chassis axle of a motor vehicle having a transverse leaf spring which is mounted via two outer bearing members on, in each case, one wheel support and via two central bearing members on a vehicle body. The outer bearing members, in each case, have an actuator device, which actuator devices act on the respective outer bearing member in such a way that it can be adjusted at least in the direction of the vertical axis of the motor vehicle. The actuator devices are configured in such a way that a respective outer bearing point can be set in the direction of the transverse axis of the motor vehicle.

### CROSS-REFERENCE TO RELATED APPLICATION

This application claims priority to German Patent Application No. DE 10 2017 113 971.0, filed Jun. 23, 2017, which is incorporated by reference herein in its entirety.

### FIELD OF THE INVENTION

The present invention relates to a transverse leaf spring arrangement of a chassis axle of a motor vehicle having a transverse leaf spring which is mounted via two outer bearing members on in each case one wheel support and via two central bearing members on a vehicle body, the outer bearing members in each case having an actuator device, which actuator devices act on the respective outer bearing member in such a way that it can be adjusted at least in the direction of the vertical axis of the motor vehicle.

### BACKGROUND OF THE INVENTION

A transverse leaf spring arrangement is part of a chassis. The wheels, the wheel suspension system, the spring system, the shock absorbers and the steering system belong to a chassis. The transverse leaf spring arrangement has substantially a transverse leaf spring which is mounted via two outer bearing members in each case to a wheel support and via two central bearing members on a vehicle body. It is possible via the configuration of the transverse leaf spring or its influence to achieve a spring rate, stabilization properties and a ride level regulation of the vehicle. Here, the spring rate has a crucial influence on the deflection of the motor vehicle, the stabilization properties have a crucial influence on the body roll behavior of the vehicle, and the ride level regulation has a crucial influence on the ride height.

DE 10 2012 009 365 A1, which is incorporated by reference herein, has then disclosed providing actuator devices on the outer bearing members, which actuator devices can be actuated in such a way that different ride heights can be set and a ride level regulation is possible in this way.

An arrangement of this type has the disadvantage, however, that exclusively the ride height of the transverse leaf spring can be set by way of the provision of two actuator devices.

### SUMMARY OF THE INVENTION

It would be desirable to provide a transverse leaf spring arrangement of a chassis axle, which transverse leaf spring arrangement avoids the abovementioned disadvantage in a simple and inexpensive way.

With that in mind, it was discovered that a respective outer bearing point can be set in the direction of the transverse axis of the motor vehicle. It is possible as a result to bring about an adaptation of chassis characteristics in a particularly simple way.

In one advantageous embodiment, at least one actuator device of an outer bearing member is configured as a linear actuator which acts in the direction of the vertical axis, a bearing head of the linear actuator being mounted displaceably in a groove member. An actuator device which can be implemented particularly simply is provided by virtue of the fact that at least one actuator device of an outer bearing member is configured as an eccentric actuator, an eccentrically mounted action member acting on the transverse leaf spring. Depending on the application, the desired actuator devices can be used, a combination of a linear actuator and an eccentric actuator also being conceivable.

Moreover, means can be provided which adjust the central bearing members in the direction of the vertical axis and/or transverse axis of the motor vehicle. It can likewise be provided in an advantageous way that the actuator devices have a torque generation apparatus, the torque direction of which runs parallel to a longitudinal axis of the motor vehicle.

### BRIEF DESCRIPTION OF THE DRAWING

The invention will be described in greater detail using a drawing, in which:

FIG. 1 shows a front view of a motor vehicle having a diagrammatically shown transverse leaf spring arrangement, and

FIG. 2 shows a diagrammatic illustration of the transverse leaf spring arrangement according to aspects of the invention having different actuator devices for the outer bearing members.

### DETAILED DESCRIPTION OF THE INVENTION

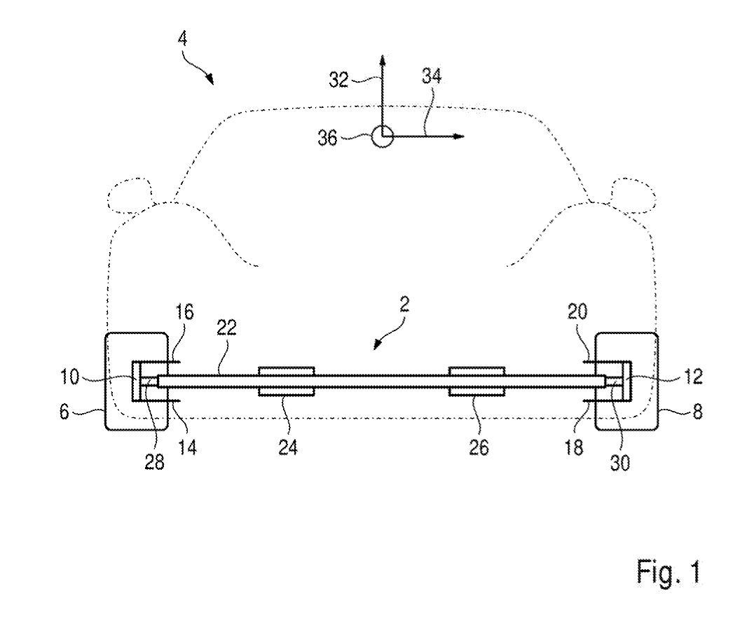

FIG. 1 shows a diagrammatic front view of a transverse leaf spring arrangement 2 according to aspects of the invention which is a constituent part of a front axle arrangement (not shown in further detail) of a motor vehicle 4. The designations 6, 8 denote two front wheels which are arranged in each case in a known way on wheel supports 10, 12. The wheel supports 10, 12 are connected, inter alia, via diagrammatically illustrated links 14, 16, 18, 20 to a vehicle body (not shown in detail) of the motor vehicle 4. A transverse leaf spring 22 of the transverse leaf spring arrangement 2 is mounted via central bearing members 24, 26 on the vehicle body of the motor vehicle 4 and via outer bearing members 28, 30 on the wheel supports 10, 12. In a known way, the motor vehicle 4 has a vertical axis 32, a transverse axis 34 and a longitudinal axis 36.

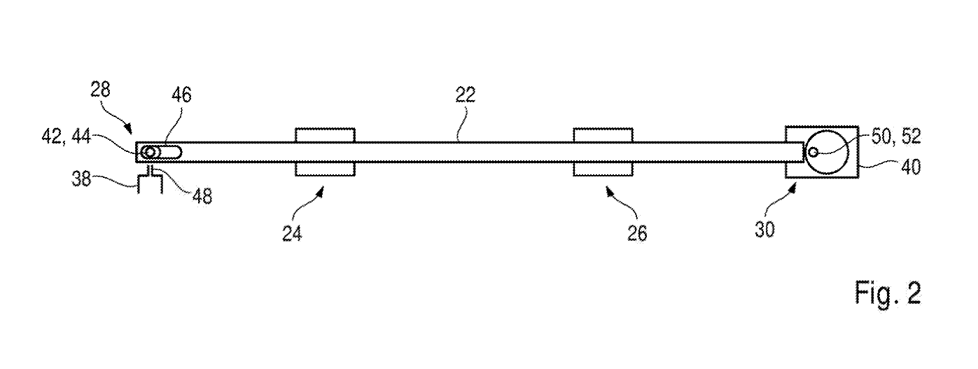

FIG. 2 shows one embodiment of a transverse leaf spring arrangement 2 according to aspects of the invention which is mounted in stationary central bearing members 24, 26 and in outer bearing members 28, 30. The outer bearing members 28, 30 then have actuator devices 38, 40 according to aspects of the invention, via which an adjustment of the outer bearing members 28, 30 is possible in the direction of the vertical axis and/or transverse axis 32, 34 of the motor vehicle 4. It is possible in a simple way as a result to set both the ride height and the spring rate of the transverse leaf spring 22.

Here, a first outer bearing member 28 has an actuator device 38 which is configured as a linear actuator. Here, the outer bearing member 28 consists of a bearing head 42 which coincides with a first bearing point 44 of the first outer bearing member 28 and is guided displaceably in a groove member 46. The linear actuator 38 acts on the bearing head 42, which linear actuator 38 has an adjustable-length coupling rod 48. As an alternative, however, the linear actuator 36 can also be configured as a spindle drive.

The second outer bearing member 30 is provided on the opposite side of the transverse leaf spring 22 and has the second actuator device 40 as an eccentric actuator here. The second bearing point 52 of the transverse leaf spring 22 is configured such that it can be adjusted in the direction of the vertical axis and/or transverse axis 32, 34 of the motor vehicle 4 via an eccentrically mounted action member 50 which coincides with a second bearing point 52 of the second outer bearing member 30.

It should be clear that many input variables can be used, in order to set the bearing points 44, 52 of the respective outer bearing members 28, 30 in the respective operating situations.

Moreover, the central bearing members 24, 26 can have a torque generation apparatus, the torque direction of which runs parallel to a longitudinal axis of the motor vehicle 4. Means can also be provided which adjust the central bearing members 24, 26 in the direction of the vertical axis and/or transverse axis 32, 34 of the motor vehicle. The means may be a linear actuator, a solenoid or a motor, for example.

What is claimed is:

1. A transverse leaf spring arrangement of a chassis axle of a motor vehicle, the transverse leaf spring arrangement comprising:
a transverse leaf spring mounted via two outer bearing members on, in each case, one wheel support,
the transverse leaf spring also being mounted via two central bearing members on a vehicle body of the motor vehicle,
the outer bearing members, in each case, having an actuator device, each to actuator device configured to act on a respective outer bearing member in such a way that the outer bearing member is configured to be adjusted at least in the direction of a vertical axis of the motor vehicle,
wherein each actuator device is configured in such a way that a respective outer bearing point is configured to be set in a direction of a transverse axis of the motor vehicle.

2. The transverse leaf spring arrangement as claimed in claim 1, wherein at least one of the actuator devices is configured as a linear actuator which acts in the direction of the vertical axis, a bearing head of the linear actuator being mounted displaceably in a groove member.

3. The transverse leaf spring arrangement as claimed in claim 1, wherein at least one of the actuator devices is configured as an eccentric actuator, an eccentrically mounted action member of the eccentric actuator acting on the transverse leaf spring.

4. The transverse leaf spring arrangement as claimed in claim 1, wherein the central bearing members have a torque generation apparatus, a torque direction of which runs parallel to a longitudinal axis of the motor vehicle.

5. The transverse leaf spring arrangement as claimed in claim 1, further comprising means for adjusting the central bearing members in a direction of the vertical axis or the transverse axis of the motor vehicle.

6. The transverse leaf spring arrangement as claimed in claim 1, further comprising means for adjusting the central bearing members in a direction of the vertical axis or the transverse axis of the motor vehicle.
